(19) United States
(12) Patent Application Publication
(10) Pub. No.: US 2006/0174629 A1
(43) Pub. Date: Aug. 10, 2006

(54) Method and system for coordinating engine operation with electrical power extraction in a more electric vehicle

(75) Inventor: Rodney G. Michalko, Queensville (CA)

Correspondence Address: Honeywell International;HONEYWELL INTERNATIONAL, INC., Law Department AB2, P.O. Box 2245, Morristown, NJ, 07962-9806, US

(73) Assignee: HONEYWELL INTERNATIONAL, INC, Morris Township, NJ (US)

(21) Appl. No.: 11/206,020

(22) Filed: Aug. 18, 2005

Related U.S. Application Data
(60) Provisional application No. 60/603,630, filed on Aug. 24, 2004.

(51) Int. Cl. B64D 41/00; F02C 6/00

(52) U.S. Cl. 60/774; 244/58

(57) ABSTRACT

A method for coordinating engine operation with electrical power extraction in a more electric vehicle provided. The method includes: receiving, by an engine control (120), a command for power output reduction of an engine (140); waiting until a predetermined event occurs to request, by the engine control (120), the power output reduction of the engine (140); reducing or completely switching off, by an electrical energy management system (110), at least one load (180) applied to a high-speed spool generator (146) connected to a high-speed spool (142) of the engine (140); reducing the power output reduction of the engine (140); and shifting power extraction from the high-speed spool generator (146) to a low-speed spool generator (148) connected to a low-speed spool (144) of the engine (140).

### CROSS-REFERENCE TO RELATED APPLICATIONS

The present application claims priority under 35 U.S.C. §119(e) of provisional patent application No. 60/603,630 filed Aug. 24, 2004, which is hereby incorporated by reference in its entirety. The present application is related to a co-pending U.S. application Ser. No. 11/199,151, filed on Aug. 4, 2005, entitled “Electrical Energy Management System On A More Electric Vehicle” and a co-pending U.S. application Ser. No. 11/196,323, filed on Aug. 9, 2005, entitled “Electrical Power Distribution System And Method With Active Load Control”, which are hereby incorporated by reference in their entirety.

### FIELD OF THE INVENTION

The present invention relates to electrical power distribution, and more particularly to a method and system that coordinates engine operability conditions with electrical power extraction in a more electric vehicle (MEV).

### BACKGROUND OF THE INVENTION

“More electric” vehicle architectures have been proposed to shift the primary power sources used for systems and services from pneumatic (engine bleed) and hydraulic sources to electric sources. Although the net power extraction from the engine may ultimately be less due to higher efficiency in the electrical extraction and distribution process, it has been determined that high electrical loads and transients can potentially cause engine instability during particular operating cases. Furthermore, due to increased electrical load in some operational modes, the engine may need to be operated at a higher power level to operate in a stable region. However, at that power level, thrust is produced which is inconsistent with the aircraft mission. Engine instability arises from the fact that in a more electric vehicle there is no pneumatic system and therefore a prime objective is to utilize an electrical starter motor to provide the initial rotational torque, accelerating the engine into a self-sustaining thermodynamic cycle. Once started, the electrical machine is then converted to an electrical generator to supply electrical energy to aircraft systems and services. In order to perform a start, the electrical machine is connected to the gas generator spool of the engine turbine.

Although necessary for start, once the electrical machine becomes a generator, the generator becomes a burden on the gas generator spool, creating a case for instability. Since the output capacity of a generator on a more electric vehicle can be three times the size of generators mounted to gas generator spools on conventional aircraft, particular areas of operation consistent with existing aircraft flight profiles can cause excessive generator power extraction while engine power is low. Furthermore, abrupt transient application or removal of significant electrical loads expected in more electric applications can, if not coordinated, cause engine stability issues regardless of engine power setting. Typical examples of operability issues are the top of descent condition and engine flight idle. Top of descent is where the aircraft transitions from cruise to descent, throttling the engines down while maintaining high electrical power demand. In this case the engine power is transiently reduced while the electrical load remains high, creating a possibility for engine instability. Also, while continuing the descent flight idle cannot be maintained due to the high electrical load, and the higher power setting required results in excess thrust. The high thrust then prevents the aircraft from letting down at a steep angle while maintaining an acceptable airspeed. As a result, means to address engine operability is desired to enable practical implementation of more electric vehicle architectures.

### SUMMARY OF THE INVENTION

The present invention overcomes the aforementioned drawbacks by providing a method and system for coordinating engine operation with electrical power extraction in a more electric vehicle.

According to one aspect of the present invention, a method for coordinating engine operation with electrical power extraction in a more electric vehicle, comprises the steps of: receiving, by an engine control, a command for power output reduction of an engine; waiting until a predetermined event occurs to request, by the engine control, the power output reduction of the engine; reducing or completely switching off, by an electrical energy management system, at least one load applied to a high-speed spool generator connected to a high-speed spool of the engine; reducing the power output of the engine; and shifting power extraction from the high-speed spool generator to a low-speed spool generator connected to a low-speed spool of the engine.

According to another aspect of the present invention, a system for coordinating engine operation with electrical power extraction in a more electric vehicle, comprises: an engine, the engine including a high-speed spool and a low-speed spool; a high-speed spool generator connected to the high-speed spool of the engine; a low-speed spool generator connected to the low-speed spool of the engine; an engine control connected to the engine, the engine control being for controlling power output of the engine, upon receiving a command for power output reduction of the engine, the engine control waiting until a predetermined event occurs to request the power output reduction of the engine; and an electrical energy management system, the electrical energy management system being connected to the engine control, the electrical energy management system controlling selectively engaging and disengaging loads of the more electric vehicle to the high-speed spool generator and the low-speed spool generator, the electrical energy management system reducing or completely switching off at least one of the loads applied to the high-speed spool generator in respond to the command, the electrical energy management system shifting power extraction from the high-speed spool generator to the low-speed spool generator by re-energizing or reconnecting previously removed loads to the low-speed spool generator while the engine reduces the power output.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 illustrates a block diagram of a system for coordinating engine operation with electrical power extraction in a more electric vehicle in accordance to an embodiment of the present invention;

FIG. 2 illustrates exemplary electrical energy management system (EEMS) interfaces between the electrical energy management controllers (EEMC's) and the electrical system in accordance with an embodiment of the present invention;

FIG. 3 illustrates exemplary EEMS interfaces among the EEMC's, the vehicle operation system, and the engine control system in accordance with an embodiment of the present invention; and

FIG. 4 illustrates an arrangement for the EEMS local data bus and discrete interfaces in accordance with an embodiment of the present invention.

### DETAILED DESCRIPTION

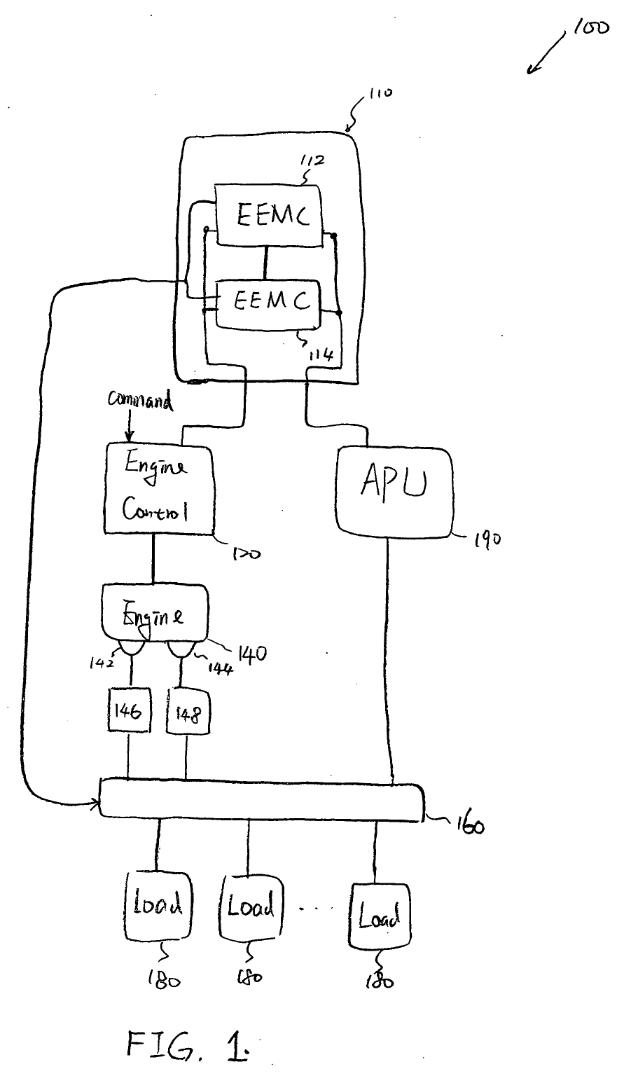

FIG. 1 illustrates a block diagram of a system for coordinating engine operation with electrical power extraction in a more electric vehicle in accordance to an embodiment of the present invention. In the illustrated embodiment, the system 100 includes an engine control 120, an engine 140, a high-speed spool generator 146 connected to the high-speed spool 142 of the engine 140, a low-speed spool generator 148 connected to the low-speed spool 144 of the engine 140, and an electrical energy management system (EEMS) 110. The engine control 120 is connected to the engine 140. The engine control 120 is for controlling the power output of the engine.

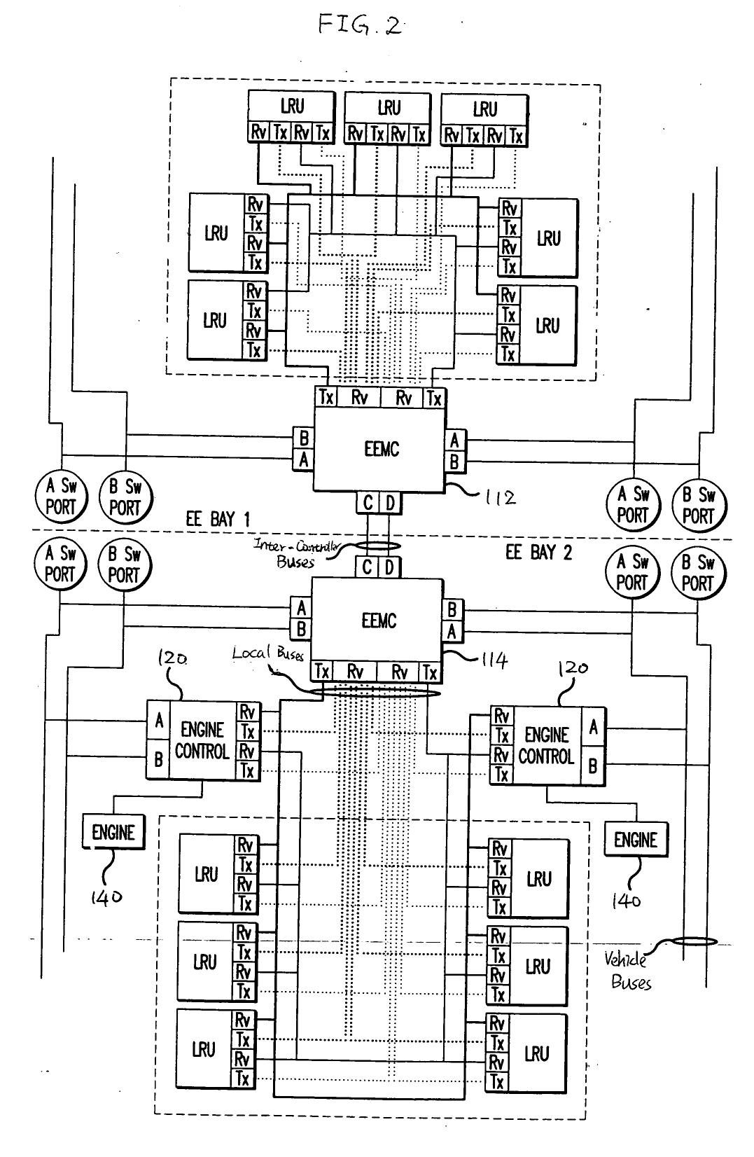

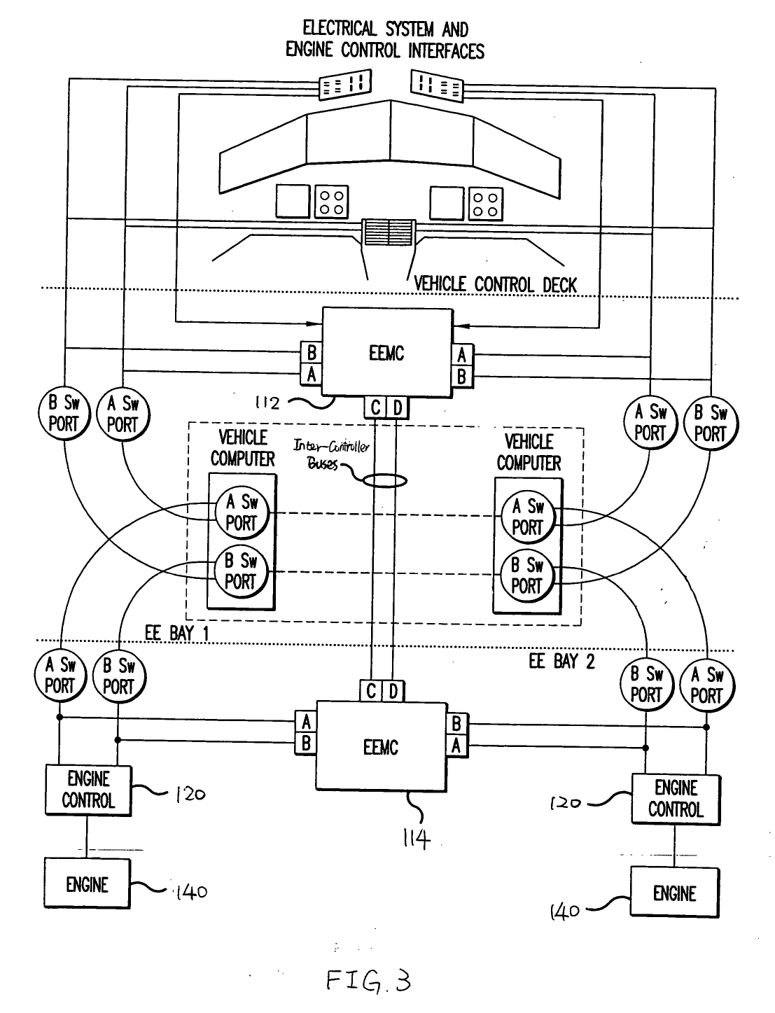

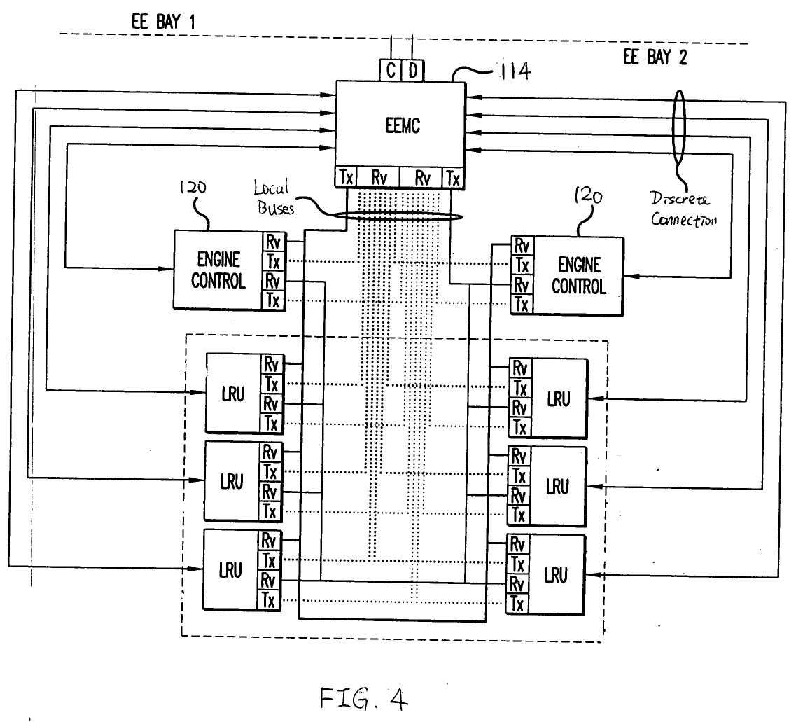

In the illustrated embodiment, the EEMS 110 serves as the interface between the electrical system and the rest of the aircraft systems and serves to provide synchronization and coordination for minimizing disturbances to engine operation while providing dependable utility equipment power availability. Such a control architecture is shown in the attached figures where two EEMC's 112 and 114 are located strategically in the aircraft to both serve as electrical system data hubs as well as provide the separation and segregation to prevent single failure events from affecting both controllers. In this architecture, the EEMS 110 has sufficient redundancy to meet criticality and availability requirements for the systems and services it supports. To solve engine operability issues, the EEMS 110 communicates with the systems and services and specifically the engine control 120 through the vehicle data buses, the electrical system private data bus or discrete wiring as appropriate to meet reliability and data latency criteria. With this configuration, engine operability issues are resolved by applying control algorithms, such as the exemplary algorithms described below. System configurations for the EEMS 110 are described in FIGS. 2-4 and in a co-pending U.S. application Ser. No. 11/199,151, filed on Aug. 4, 2005, entitled “Electrical Energy Management System On A More Electric Vehicle”, which is incorporated by reference in its entirety.

The example of the top of descent condition described earlier will be used to illustrate the method and the system to coordinate engine operation with electrical power extraction in a more electric vehicle. It should be noted that although the illustrated embodiment uses the more electric aircraft (MEA) as an example, the present invention can be applied to other types of more electric vehicles.

Upon receiving a command, for example, from the control deck of the more electric vehicle such as a flight deck of the more electric aircraft, for power output reduction of the engine 140, the engine control 120 delays its action as the EEMS 110 is informed of the power setting change. The engine control 120 waits until a predetermined event occurs to request the power output reduction of the engine 140.

In an embodiment, the engine control 120 communicates that action to the EEMS 110 and either waits for the EEMS 110 to respond that the EEMS 110 had taken the appropriate action or, provides a fixed time delay after which the engine control 120 exercises the requested power reduction regardless of EEMS 110 action or, provides a fixed time delay during which the EEMS 110 can advise the engine control 120 that the correct action has been taken so that the engine control 120 can proceed with its action earlier but within the fixed delay period.

Since a prolonged power setting change, after request by the pilot due to the absence of the EEMS 110 response, could have significant effect on the control and stability of the vehicle, it may be preferred to set a maximum waiting period for the engine control 120 to take the next action. This maximum waiting period can be adjusted for different flight phases and flight conditions. Such a flight phase can be take-off and landing where pilot inputs to engine power are frequent and crucial to safe operation. In this case the maximum waiting period can be short since the aircraft is at low altitude and the cabin pressurization loads are reduced, placing less demand on the engine accessory output power extraction.

When the EEMS 110 is informed of the power setting change, the EEMS 110 evaluates its current status. The EEMS 110 constantly monitors the function of its components and systems to determine the available power that it has to distribute between the aircraft loads. The status is determined by monitoring a multitude of parameters within the system such as but not limited to, availability, voltage and current of power sources, rotational speed of generator, operating temperature of electrical equipment, ambient temperature and altitude where that may effect output (cooling), failures of equipment or bus architecture, total load requests from all systems compared to priority for those services, etc.

After checking its status, the EEMS 110 switches off at least one load 180 applied to the high-speed spool generator 146 connected to the high-speed spool 142 of the engine 140, for example, through the switch 160. The EEMS 110 follows a hierarchical reduction in power loads depending upon the predetermined criticality of the service. In one implementation, such services are shed in groupings based upon their bus connection and system criticality.

Practically, the first loads to shed are those connected to the non-essential buses and could consist of galley, entertainment, and selected cabin lighting etc. The second loads to shed can be some technical loads and redundant essential systems that are not currently required for safe flight and landing. The last loads that can be shed are essential loads that would not impact continued safe flight and landing albeit at a considerably reduced operational capability. The latter two cases are dependent upon the vehicle and the systems design and redundancy employed.

In an embodiment, the EEMS 110 slows down at least one motor controller of the more electric vehicle through motor speed controls to temporarily relieve the burden on the high-speed spool generator 146. For example, the Cabin Air Compressor motor drives (electronic motor controllers) as well as other large motor controllers that may be in the system can be speed controlled. These motor controllers employ active power conversion techniques that consume only the amount of power necessary to satisfy the horsepower extraction demands of the compressor or other motor that is being driven. Therefore, if the motor controller is slowed down, the horsepower consumed is reduced and the electrical power demand on the engine is reduced.

Since cabin pressurization is maintained by the outflow valves, the pressure does not immediately reduce. Therefore, a short period is available to reduce power demand from the engine without loss of cabin pressurization. In addition, since such a condition is most likely to occur at the top of descent, the descent profile will provide continually increasing external air pressure which would require less pressurization by the air compressors, minimizing the effect of a slowed compressor motor.

As mentioned, in the illustrated embodiment, the engine control 120 waits until a predetermined event occurs to request the power output reduction of the engine 140. After the predetermined event occurs (for example, the EEMS 110 responds in a predetermined period of time, etc.), the engine control 120 requests the power output reduction of the engine 140 and the engine 140 reduces its power output.

The engine reduction in power occurs depending upon the methodology described above. From an aircraft handling perspective, the pilot would not detect a delay in the reduction of power but within the aircraft systems a delay or waiting period as described occurs to coordinate the engine power production and electrical power extraction. Hence the engine 140 starts its action and makes the power reduction delay inclusive of that action. With the advanced warning of the impending engine power reduction, the EEMS 110 begins the process to match the engine power reduction with a corresponding electrical power extraction. The amount of power reduction or the switching off of loads begins but the magnitude of the reductions depends upon the magnitude of the engine power reduction. The communications network between the engine control 120 and the EEMS 110 communicates the magnitude of the power reduction since engine and electrical system stability benefits from properly balanced power adjustments.

As the descent is established, the EEMS 110 shift power extraction from the high-speed spool generator 146 to the low-speed spool generator 148. In an embodiment, the EEMS 110 may adjust the electrical generation and distribution system to shift the power extraction from the high-speed spool generator 146 to the low-speed spool generator 148.

The normal starter generator of the MEA aircraft electrical system is connected to the high-speed spool or gas turbine 142. Another turbine assembly is the low-speed spool or turbine 144 that is attached via a shaft through the center of the engine 140 to a compressor fan at the front of the engine 140 and that assembly or “spool” freely rotates independent of the high-speed turbine 142, which is constructed around the low-speed spool shaft. Therefore, when the engine 140 starts, the high-speed turbine 1.42 is rotated by the starter generator, fuel is added and ignited, and the high-speed turbine 142 reaches self sustaining operation. The product of the high-speed turbine 142 is an expanding gas that passes over the power turbine connected to the shaft passing forward through the engine 140 to the compressor fan. This expanding gas rotates the power turbine and the attached compressor fan provides a supercharger compression of intake air to the high-speed turbine 142, increasing high-speed turbine performance. The exhausting gas exiting the power turbine area and the back of the engine leaves as thrust. In high bypass engines, only a portion of the compressed air is applied to the high-speed turbine intake while the remaining relatively large volume of air being compressed, bypasses the engine assembly and exits the engine as additional thrust.

During takeoff, cruise or other high power settings, the engine high-speed turbine 142 produces sufficient power to provide a portion of that power to drive the high output capacity generators. However, at low power settings the high-speed turbine 142 does not provide excess capacity and the thermodynamic cycle of the turbine can become unstable due to the low surge margin. Operationally, there are cases where a low power setting is required and hence the conflict arises between electrical power extraction and engine power setting. This problem manifests itself most noticeably at the top of descent case. When the aircraft transitions from cruise to descent, the engine power (thrust) is reduced to allow the aircraft to descend. When this occurs, the electrical power extraction is still high and could cause the engine to become unstable. If engine power is maintained higher than normal to prevent the engine instability, the aircraft would not descend quickly enough, lengthening the descent phase (which is a fuel inefficient operational combination) or result in a significantly higher than normal airspeed during descent (steeper pitch angle).

At this point, if the power extraction is shifted to the independently spinning low-speed turbine 144, the fan itself, exposed to the incident airflow during descent becomes a wind turbine in itself, driving the generator 148 attached to the low-speed turbine 144. The high-speed turbine 142, now relieved of its electrical power extraction burden, can now be throttled back to provide the required thrust for descent. Although the low-speed turbine 144 provides an attractive point for power extraction under this case when it is basically windmilling, its overall speed variation over the entire engine operating envelop is much too high to suit electrical generator design constraints.

In addition, since the low-speed and high-speed turbines 142 and 144 are not mechanically coupled, the high-speed turbine 142 may be rotated by the starter generator to perform an engine start thus requiring generators 146 and 148 on both high- and low-speed turbines 142 and 144. In an embodiment, whereas a high-speed turbine speed ratio is approximately 2:1, a low-speed turbine ratio is approximately 5:1 and this results in favoring the low-speed turbine 144 at windmilling speed. Electrically and or mechanically disabling the generator output at higher speed prevents the low-speed turbine mounted generator 148 from being operated outside its design constraints. The gearing between the high-speed turbine 142 or the low-speed turbine 144 and the generator output shaft adjusts the actual speed at the generator.

The high- and low-speed turbines 142 and 144 are part of the same engine 140 but are de-coupled mechanically and depend upon gas coupling (high-speed turbine air flowing over the low-speed power turbine blades) to transfer power from the high to low power turbines. Since the low-speed turbine is free spinning, the windmill effect on the compressor fan provides the motive force for the generator during descent and low engine power condition such as cruise. High power settings result in fan speeds that are beyond normal generator design parameters and hence the power extraction is transferred back to the high-speed turbine 142.

The low-speed turbine shaft assembly or spool 144 is either driven by the output expanding gases from the high-speed turbine 142 or can be driven by the incident airflow on the fan. During mid engine power settings such as cruise, both the low- and high-speed turbines can be within the correct speeds for the respective generator operations. In such case the amount of extraction from either turbine can be adjusted by the EEMS 110 through the electrical generation and distribution system to maintain both the desired electrical output for services while balancing the power extraction from both turbines and maintain a stable engine operation. During minimum power settings, all power may be extracted from the low-speed spool generator 148, while at high power settings all power may be extracted from the high-speed generator 146.

In the illustrated embodiment, the system 100 further includes an auxiliary power unit (APU) 190. In the event that the aircraft or engine design or operational mode cannot support a stable engine operation after the initial electrical power extraction transition, the ability to automatically start the APU 190 and bring its electrical generators on line provides the additional supplement of power to support aircraft systems.

The APU installation, by design intent, provides an electrical power source independent of propulsion engine operation. Therefore if supplemental power is required, the APU 190 can be used without impact to the main engine operation. Use of the APU 190 may result in lower fuel efficiency than that of the main engines when used as a source of mechanical energy to drive electrical generators. Therefore it may be desirable to use the APU 190 only when required instead of continuously as a backup power source.

In such a scenario, the aircraft EEMS 110 and the engine control 120 conduct a power transition as described earlier. However, if after unloading the high-speed spool engine power extraction, the load 180 could not be reapplied to the low speed spool generator due to operational or failure conditions, the EEMS 110 automatically starts the APU 190 to supplement the required power until normal operations could be established. Since the time between recognition of a power shortage and the start of the APU 190 should be kept to a minimum, automatic starting of the APU 190 lessens the transition time or makes it a seamless transition with respect to aircraft operation. In this transition, the EEMS 110 first off loads the engine power extraction and then reapplies the load 180 to both the generator and the APU 190 to regain the necessary electrical services.

The APU operation on ground is also a potential advantage as the speed of the high-speed turbine 142 necessary to power the aircraft electrical loads 180 on the ground may result in thrust outputs that do not facilitate stationary operation on the ground (without excessive application of brakes or other aircraft restraint method such as wheel chocking). The low-speed turbine 144 would not have the windmilling effect that it experiences in flight and hence will not be of any value on the ground. In this case the APU 190 provides a solution that the EEMS 110 can coordinate on initial power up and then shut down automatically on the takeoff roll or in climb as the high-speed turbine 142 becomes effective.

In addition, when the APU 190 starts to provide the additional supplement of power to support aircraft systems, the EEMS may blend the power output of the APU 190 with the power output of either or both of the high-speed spool generator 146 and the low-speed spool generator 148. The power sequencing and blending function is a sub-tier operation that occurs as one method that the EEMS 110 can use to balance power between engine generators 146 and 148 on the same engine 140 or between engines 140 or between the APU 190 and the engine 140. Such action avoids the need to actually shed, transfer or disconnect loads and since that activity requires a finite time to mechanically switch connections in the system, the active load control can offer an advantage due to the much faster transition of loads from one source to another electronically. System configurations for achieving effective blending of electrical power are described in a co-pending U.S. application Ser. No. 11/196,323, filed on Aug. 9, 2005, entitled “Electrical Power Distribution System And Method With Active Load Control, which is incorporated by reference in its entirety.

What is claimed is:

1. A method for coordinating engine operation with electrical power extraction in a more electric vehicle, comprising the steps of:
receiving, by an engine control, a command for power output reduction of an engine;
waiting until a predetermined event occurs to request, by the engine control, the power output reduction of the engine;
switching off, by an electrical energy management system, at least one load applied to a high-speed spool generator connected to a high-speed spool of the engine;
reducing the power output of the engine; and
shifting power extraction from the high-speed spool generator to a low-speed spool generator connected to a low-speed spool of the engine.

2. The method of claim 1, wherein the predetermined event occurs when a predetermined time period expires.

3. The method of claim 1, wherein the predetermined event occurs when, within a predetermined time period, the electrical energy management system switches off the at least one load so that the power reduction of the engine is not more than the at least one load.

4. The method of claim 1, further comprising evaluating a status of the electrical energy management system by the electrical energy management system before the step of switching off the at least one load of the more electric vehicle.

5. The method of claim 4, wherein the step of the status of the electrical energy management system includes evaluating current available power to be distributed between the loads of the more electric vehicle.

6. The method of claim 1, wherein the step of switching the at least one load off includes switching the load unnecessary for current safety of flight and landing.

7. The method of claim 1, wherein the step of switching the at least one load off includes slowing at least one motor controller of the more electric vehicle.

8. The method of claim 7, wherein the at least one motor controller is a cabin air compressor motor drive.

9. The method of claim 1, wherein the more electric vehicle is a more electric aircraft.

10. The method of claim 9, wherein the step of shifting the power extraction is performed when the more electric aircraft begins to descend.

11. The method of claim 1, wherein the step of shifting the power extraction includes adjusting an electrical generation and distribution system by the electrical energy management system.

12. The method of claim 1, further comprising reapplying the at least one load to the low-speed spool generator.

13. The method of claim 1, further comprising automatically starting an auxiliary power unit by the electrical energy management system to supplement the power extraction from either or both of the high-speed spool generator and the low-speed spool generator.

14. The method of claim 13, wherein the power output of the auxiliary power unit is independent of the power output of the engine.

15. The method of claim 13, further comprising reapplying the at least one load to the auxiliary power unit.

16. The method of claim 13, further comprising blending, by the electrical energy management system, the power output of the auxiliary power unit with the power output of either or both of the high-speed spool generator and the low-speed spool generator.

17. A system for coordinating engine operation with electrical power extraction in a more electric vehicle, comprising:
an engine, the engine including a high-speed spool and a low-speed spool;
a high-speed spool generator connected to the high-speed spool of the engine;
a low-speed spool generator connected to the low-speed spool of the engine;
an engine control connected to the engine, the engine control being for controlling power output of the engine, upon receiving a command for power output reduction of the engine, the engine control waiting until a predetermined event occurs to request the power output reduction of the engine; and
an electrical energy management system, the electrical energy management system being connected to the engine control, the electrical energy management system controlling selectively engaging and disengaging loads of the more electric vehicle to the high-speed spool generator and the low-speed spool generator, the electrical energy management system switching off at least one of the loads applied to the high-speed spool generator in respond to the command, the electrical energy management system shifting power extraction from the high-speed spool generator to the low-speed spool generator after the engine reduces the power output.

18. The system of claim 17, further comprising an auxiliary power unit, the electrical energy management system automatically starting the auxiliary power unity to supplement the power extraction from either or both of the high-speed spool generator and the low-speed spool generator.

19. The method of claim 18, wherein the predetermined event occurs when a predetermined time period expires.

20. The method of claim 18, wherein the predetermined event occurs when, within a predetermined time period, the electrical energy management system switches off the at least one of the loads so that the power reduction of the engine is not more than the at least one of the loads.
